(19) United States
(12) Patent Application Publication
(10) Pub. No.: US 2012/0132829 A1
(43) Pub. Date: May 31, 2012

(54) ROBOTIC ARM AND TRANSPORTING DEVICE WITH THE SAME

(75) Inventor: Yun Wang, Guangdong (CN)

(73) Assignee: SHENZHEN CHINA STAR OPTOELECTRONICS TECHNOLOGY CO., LTD., Shenzhen (CN)

(21) Appl. No.: 13/000,165

(22) PCT Filed: Nov. 26, 2010
(86) PCT No.: PCT/CN10/79154

§ 371 Date: Dec. 20, 2010

(51) Int. Cl. G21K 5/00; B01D 46/00; B25J 18/02

(52) U.S. Cl. 250/454.11; 74/490.05; 55/385.1; 901/28; 901/30

(57) ABSTRACT

The present invention discloses a robotic arm including a supporting member, a cavity body and a telescopic member. The cavity body includes a gate. The cavity body accommodates the supporting member. The telescopic member is connected with the supporting member for driving the supporting member to extend out of or back to the cavity body through the gate. The present invention discloses a transporting device with the robotic arm. The robotic arm and the transporting device with the robotic arm utilizes the structure of the cavity body to maintain the cleanliness during transporting plates.

### BACKGROUND OF THE INVENTION

1. Field of the Invention

The present invention generally relates to a robotic arm and a transporting device with the robotic arm, and particularly to a robotic arm and a transporting device with the robotic arm for transporting a liquid crystal display panel.

2. Description of Prior Art

Manufacturing process of the liquid crystal display panel includes an array process in first stage, a cell process in middle stage and a module process in last stage. The array process in first stage is provided for manufacturing a Thin Film Transistor (TFT) substrate and a color filter substrate. The cell process in middle stage is provided for assembling the TFT substrate with the color filter substrate, injecting the liquid crystal therebetween, and cutting the panel in a product size. The module process in last stage is an assembling process for assembling the assembled panel with a back light module, a panel driving circuit, an external frame and so on.

During the cell process in middle stage, firstly, the color filter substrate is dispensed with sealant thereon for assembling TFT substrate and the color filter substrate. Then the liquid crystal is dripped on the color filter substrate with a required liquid crystal amount. A robotic arm transports the TFT substrate and the color filter substrate into a laminating machine for assembling the TFT substrate and the color filter substrate in a vacuum circumstance and then for subsequent alignment process and combination process. Subsequently, the robotic arm transports the laminated panel to a plastic frame hardening oven, a thermal curing oven and so on for performing hardening and thermal-curing process of the plastic frame.

However, with the increase of the panel size, the robotic arm must increase its size and scope of activities, speed. It is well known that a yield rate of liquid crystal display panel produce is closely related to dust particles in the environment. Movement in high speed and large scope will inevitably kick up dusts, thereby demanding a cleaner environment in entire transporting process. Production line of liquid crystal display panel needs further requirements for the clean room.

Furthermore, during fetching and transporting the substrates, the traditional robotic arm leaves the substrates exposed to the outside. During maintenance operation, a personnel or equipment tends to inevitably touch the substrates and causes the substrates to be broken.

On the other hand, with the recent emergence of a visible light plastic frame, visible light (wavelength of 420 nm or more) waves are commonly used to harden the visible light plastic frame, instead of using traditional UV lamp, thereby saving mask cost and completely avoiding the impact of 365 nm wavelength ultraviolet light on the liquid crystal. However, the visible light plastic frame is sensitive to visible light, so while the robotic arm transports the TFT substrate and the color filter substrate, the visible light plastic frame under prolonged exposure to visible light will lead to unnecessary hardening, resulting in liquid crystal leakage and other quality problems.

### SUMMARY OF THE INVENTION

To solve the above-mentioned problem, an objective of the present invention is to provide a robotic arm with a cavity body.

Another objective of the present invention is to provide a transporting device with a robotic arm for transporting simultaneously a TFT substrate and a color filter substrate for solving the above-mentioned problems.

To achieve the above objective, the invention provides a robotic arm comprising a supporting member, a cavity body and a telescopic member. The cavity body includes a gate. The cavity body accommodates the supporting member. The telescopic member is connected with the supporting member for driving the supporting member to extend out of or back to the cavity body through the gate.

In a preferred embodiment, the cavity body comprises a fan filter unit, the air is processed by the fan filter unit and then is supplied into the cavity body. Furthermore, the cavity body comprises a light source therein. The wavelength of light emitted by the light source is within a range of the visible light. The robotic arm further comprises a lighting controller for controlling turning on or off of the light source. The lighting controller turns on the light source during the transporting process of the robotic arm.

It is noted that the telescopic member is a telescopic rod. The robotic arm further comprises a supporting structure for supporting the cavity body.

To achieve the above-mentioned another objective, the invention provides a transporting device with the robotic arm. The transporting device includes at least one robotic arm. Each robotic arm comprises a supporting member, a cavity body and a telescopic member. The cavity body includes a gate. The cavity body accommodates the supporting member. The telescopic member is connected with the supporting member for driving the supporting member to extend out of or back to the cavity body through the gate. As mentioned earlier, the cavity body contains a fan filter unit, the air is processed by the fan filter unit and then is supplied into the cavity body.

The robotic arm and the transporting device with the robotic arm in accordance with the present invention are provided for transporting the TFT substrate and the color filter substrate in a cell process, and accommodating the TFT substrate and the color filter substrate in the cavity body. Because the cavity body has an internal space much smaller than that of a clean room, the internal space of the cavity body is capable of achieving a very high cleanliness, thereby solving the problems of low cleanliness and easily being damaged of traditional robotic arm which leaves the TFT substrate and the color filter substrate exposed to the outside. Moreover, the light source being provided in the cavity body not only solves the problem that plastic frame is sensitive to visible light, but also is capable of irradiating the plastic frame during transporting to complete the hardening step, thereby reducing the process of transporting the plastic frame to the plastic frame hardening oven, and therefore reducing the cost.

The present invention may be better understood through the following description with reference to the accompanying drawings, wherein:

### BRIEF DESCRIPTION OF THE DRAWINGS

FIG. 1 is a schematically perspective view of a robotic arm in accordance with a preferred embodiment of the present invention.

FIG. 2 is a schematically perspective view of a telescopic member of a preferred embodiment of the present invention.

FIG. 3 shows a transporting device in accordance with a preferred embodiment of the present invention.

### DETAILED DESCRIPTION OF THE PREFERRED EMBODIMENT

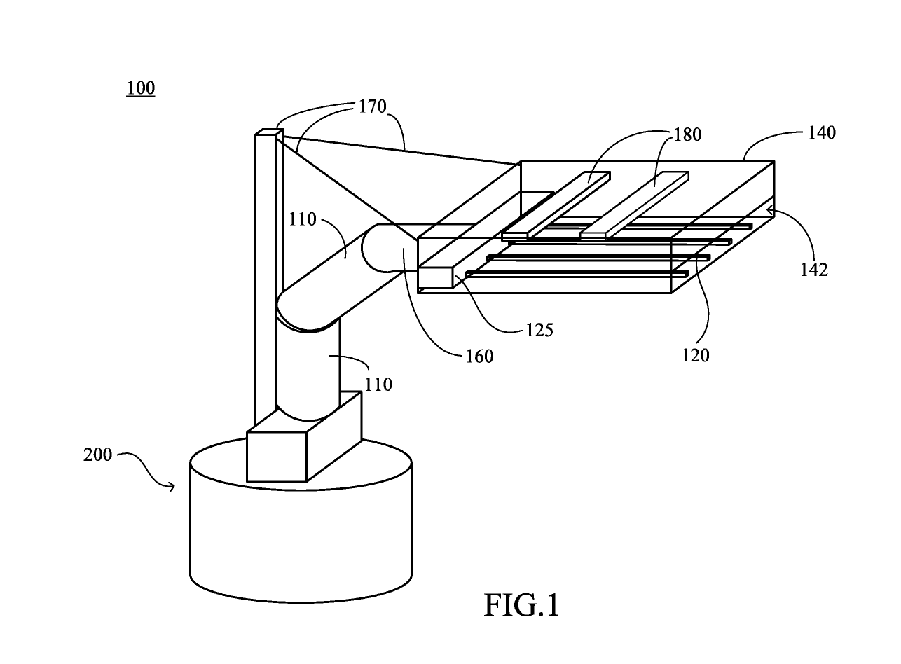

Please referring to FIG. 1, FIG. 1 is a schematically perspective view of a robotic arm in accordance with a preferred embodiment of the present invention. A robotic arm 100 in accordance with a preferred embodiment of the present invention is mounted on a pedestal body 200. The robotic arm 100 is used for transporting plates (not shown). The plate type of glass substrates may be a TFT substrate and a color filter substrate, or a laminated panel, especially a large-size panel. The robotic arm 100 comprises a plurality of arms 110, a supporting member 120, a cavity body 140 and a telescopic member 160. The plurality of arms 110 are combined by a plurality of joints (not shown), and the movement of the arms 110 can be controlled by a computer.

The supporting member 120 is used to support the plate. Preferably, the supporting member 120 is formed by an arrangement of a number of cylinders and is mounted on a base 125. Furthermore, the number of cylinders and the base 125 can also be integrally formed.

For clarity, the cavity body 140 is shown in a perspective view. The cavity body 140 is mounted on the arms 110. The cavity body 140 is provided for accommodating the supporting member 120 and the plate, and can be moved with the arms 110. Specifically, the cavity body 140 is a flat opaque container. The cavity body 140 comprises a gate 142, and the gate 142 is normally closed for sealing the plate, such as the TFT substrate and the color filter substrate, thereby preventing dust particles falling on the plate. In addition, the gate 142 can be opened to a sufficient width to allow the supporting member 120 to extend out of the cavity body 140.

In the preferred embodiment, the cavity body 140 has a fan filter unit (not shown) formed on a top surface of the cavity body 140. The air is processed by the fan filter unit and then is supplied into the cavity body 140 for maintaining the cleanliness in the cavity body 140. Rather, the fan filter unit is an end air supply unit with power and a filtering function. The air is inhaled by a fan from the top of the fan filter unit and is filtered by a primary-efficiency-particulate-arresting filter and a high-efficiency-particulate-arresting filter. Cleaned air after being filtered is evenly supplied into the cavity body 140 for improving the cleanliness of air in the cavity body 140, and even making the amount of dust, whose size is greater than 0.3 microns, less than 10 per cubic foot in the cavity body 140.

In the preferred embodiment, the cavity body 140 further comprises a light source, such as lamp members 180 mounted on a internal top surface of the cavity body 140. The light source emits light, a wavelength of which is within a wavelength range of the visible light, such as T5 lamp (wavelength above 380 nm) of visible light lamp. The light source can also be a UV light (wavelength of 380 nm˜470 nm) in addition to that the wavelength of emitting light within the wavelength range of the visible light. In addition, the robotic arm 110 also includes a lighting controller (not shown). The lighting controller is connected with the light source (for example the lamp members 180) for controlling irradiation time of the light source and controlling turning on or off of the light source. As a result, excepting having a function similar to a black box, the cavity body 140 also has a function of hardening the plastic frame.

The robotic arm 100 in accordance with the present invention is used in a process of manufacturing a visible light plastic frame. After dispensing sealant, the robotic arm 100 fetches the TFT substrate and the color filter substrate in the cavity body 140 (at the moment the light source is turned off, the cavity body 140 is similar to a dark chamber), thereby avoiding the impact of external light on the plastic frame and significantly avoiding advanced hardening problem of the plastic frame. Furthermore, after the TFT substrate and the color filter substrate are laminated, the lamp members 180 mounted on the top of the cavity body 140 is turned on so that the plastic frame is gradually hardened in the irradiation of the visible light wavelength, thereby preventing the plastic frame from being damaged by the atmospheric to cause leakage of liquid crystal during transporting the plastic frame to the plastic frame hardening oven. Furthermore, the robotic arm 100 in accordance with the present invention utilizes the lighting controller to control irradiation time of the visible light lamp, so that the panel is irradiated during being transported to complete hardening the plastic frame, and then is transported to the thermal curing oven, thereby reducing the cost of UV hardening furnace and space.

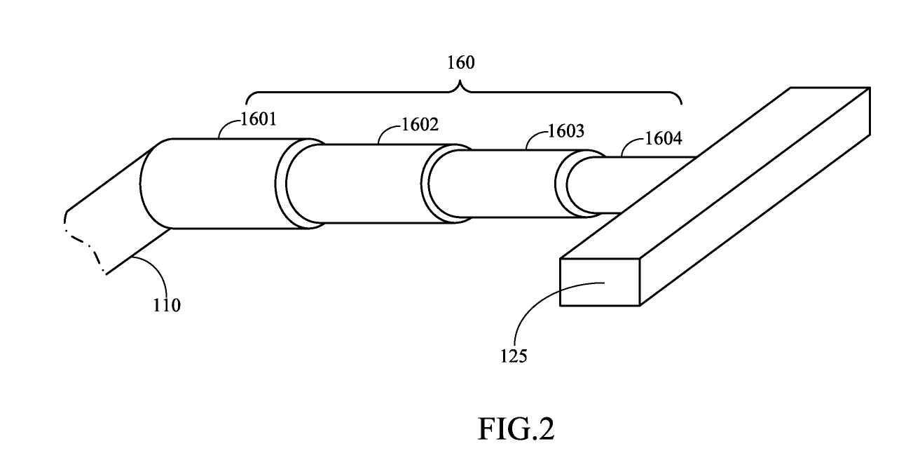

Referring to FIGS. 1 and 2, FIG. 2 is a schematically perspective view of the telescopic member 160 in accordance with a preferred embodiment of the present invention. For clarity, the cavity body 140 and the supporting member 120 are not shown in FIG. 2 but can be referred to FIG. 1. The telescopic member 160 is connected to the supporting member 120 for driving the supporting member 120 to extend out of or back to the cavity body 140 through the gate 142. The telescopic member 160 is provided for extending the supporting member 120 out of the gate 142 to fetch and place the plate. Specifically, the telescopic member 160 is mounted on the arm 110, or mounted in the arm 110, with one end connected with the arm 110 and the other end connected with the base 125.

In the preferred embodiment, the telescopic member 160 is a telescopic rod. The telescopic rod is formed by a plurality of sleeves 1601, 1602, 1603, 1604 of progressively smaller diameters. An end of the largest diameter sleeve 1601 is connected with the arm 110 and an end of the smallest diameter sleeve 1604 is connected with the base 125. The sleeves 1601, 1602, 1603, 1604 slide relative to each other for driving the base 125 to push the supporting member 120 out of the cavity body 140, thereby fetching and placing the plate. The telescopic member 160 of the present invention may be an oil pressure equipment (not shown). The oil pressure equipment comprises a hydraulic cylinder connected with the base 125 for pushing out the supporting member 120.

Referring again to FIG. 1, in the preferred embodiment, the robotic arm 100 further comprises a supporting structure 170 for supporting the cavity body 140 on the arm 110, thereby stabilizing the cavity body 140. However the invention is not limited to the supporting structure 170 shown in FIG. 1, other supporting structure can be implemented.

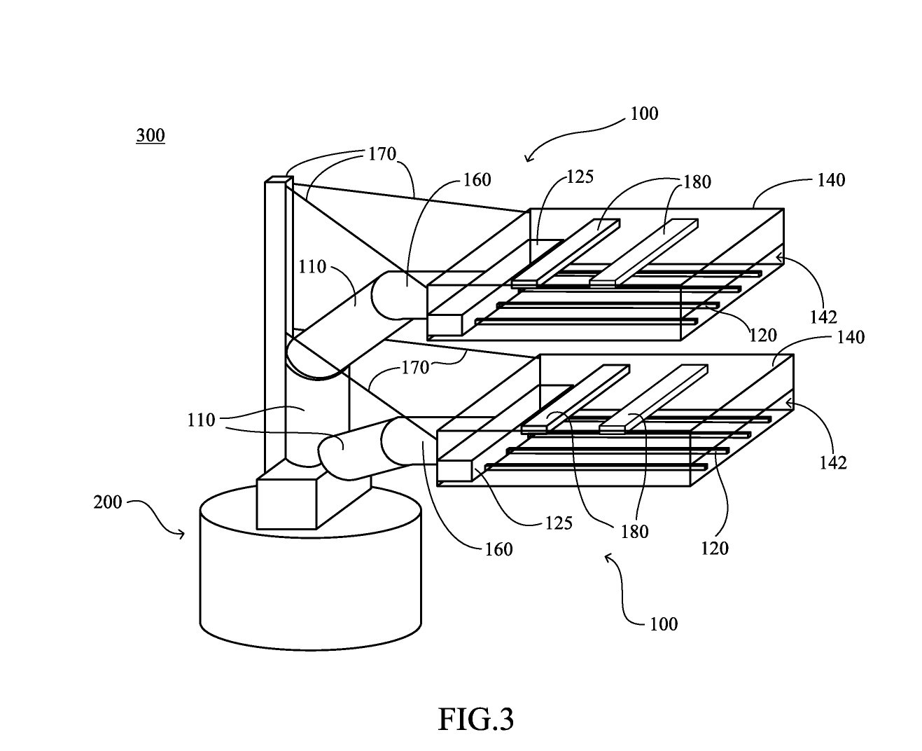

Referring to FIG. 3, FIG. 3 shows a transporting device in accordance with a preferred embodiment of the present invention. The following text describes a transporting device 300 with the robotic arms 100 in accordance with the present invention, omitting the description of the same components of the robotic arm 100. The transporting device 300 comprises at least one robotic arm 100 for transporting a plurality of plates (not shown). Each robotic arm 100 comprises a supporting member 120, a cavity body 140 and a telescopic member 160. The cavity body 140 comprises a gate 142, and the cavity body 140 is provided for accommodating the supporting member 120. The telescopic member 160 is connected with the supporting member 120 for driving the supporting member 120 to extend out of or back to the cavity body 140 through the gate 142. As mentioned earlier, the cavity bodies 140 comprise a fan filter unit, respectively. The air is processed by the fan filter unit and then is supplied into the cavity body.

It is understandable that the transporting device 300 in accordance with the present invention may dispose two or more identical robotic arms 100 on a same pedestal body 200 at the same time, thereby transporting multiple plates simultaneously. The description of the same components is referred to earlier description and FIGS. 1 and 2, and is not repeated here.

As stated previously, the robotic arm in accordance with the present invention is provided for transporting the TFT substrate and the color filter substrate in a cell process and accommodating the TFT substrate and the color filter substrate in the cavity body. Because of the narrow space inside the cavity body, the internal space of the cavity body is capable of achieving a very high cleanliness, thereby solving the problem of low cleanliness and easily broken of traditional robotic arm which leaves the TFT substrate and the color filter substrate exposed to the outside. Moreover, lamps being provided in the cavity body not only solves the problem that plastic frame is sensitive to visible light, but also is capable of irradiating the plastic frame during transporting to complete the hardening step, thereby reducing the process of transporting the plastic frame to the plastic frame hardening oven, and therefore reducing the cost.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A plate transporting device, comprising at least one robotic arm for transporting a plurality of plates, characterized in that: each robotic arm comprising:
a supporting member for supporting the plates;
an opaque cavity body having a filtering function and comprising a gate, the cavity body accommodating the supporting member and the plates, air being filtered and then supplied into the cavity body;
a telescopic member being connected with the supporting member for driving the supporting member to extend out of or back to the cavity body through the gate for fetching the plates.

2. The transporting device according to claim 1, characterized in that: the cavity body has a fan filter unit provided therein, the air is processed by the fan filter unit and then is supplied into the cavity body.

3. The transporting device according to claim 1, characterized in that: the cavity body has a light source provided therein.

4. The transporting device according to claim 3, characterized in that: the robotic arm further comprises a lighting controller for controlling turning on or off of the light source.

5. The transporting device according to claim 4, characterized in that: the lighting controller turns on the light source during movement of the robotic arm, thereby irradiating the plates.

6. A robotic arm, characterized in that: the robotic arm comprising:
a supporting member;
a cavity body, comprising a gate, the cavity body accommodating the supporting member;
a telescopic member being connected with the supporting member, for driving the supporting member to extend out of or back to the cavity body through the gate.

7. The robotic arm according to claim 6, characterized in that: the cavity body has a fan filter unit provided therein, the air is processed by the fan filter unit and then is supplied into the cavity body.

8. The robotic arm according to claim 6, characterized in that: the cavity body has a light source provided therein.

9. The robotic arm according to claim 8, characterized in that: the wavelength of light emitted by the light source is within a range of the visible light.

10. The robotic arm according to claim 8, characterized in that: the robotic arm further comprises a lighting controller for controlling turning on or off of the light source.

11. The robotic arm according to claim 10, characterized in that: the lighting controller turns on the light source during movement of the robotic arm.

12. The robotic arm according to claim 6, characterized in that: the telescopic member is a telescopic rod.

13. The liquid crystal display according to claim 6, characterized in that: the robotic arm further comprises a supporting structure for supporting the cavity body.

14. A transporting device, comprising at least one robotic arm, characterized in that: each robotic arm comprising:
a supporting member;
a cavity body comprising a gate, the cavity body accommodating the supporting member;
a telescopic member being connected with the supporting member, for driving the supporting member to extend out of or back to the cavity body through the gate.

15. The transporting device according to claim 14, characterized in that: the cavity body has a fan filter unit provided therein, the air is processed by the fan filter unit and then is supplied into the cavity body.

16. The transporting device according to claim 14, characterized in that: the cavity body has a light source provided therein.

17. The transporting device according to claim 16, characterized in that: the wavelength of light emitted by the light source is within a range of the visible light.

18. The transporting device according to claim 16, characterized in that: the robotic arm further comprises a lighting controller for controlling turning on or off of the light source.

19. The transporting device according to claim 18, characterized in that: the lighting controller turns on the light source during movement of the robotic arm, thereby irradiating plates.

20. The transporting device according to claim 14, characterized in that: the telescopic member is a telescopic rod.
